(19) United States
(12) Patent Application Publication
(10) Pub. No.: US 2025/0124185 A1
(43) Pub. Date: Apr. 17, 2025

(54) METHODS AND SYSTEMS FOR OPERATING INDUSTRIAL CONTROL LOOPS

(71) Applicant: Siemens Aktiengesellschaft, München (DE)

(72) Inventors: Michael Leipold, Nürnberg (DE); Christian Neugebauer, Nürnberg (DE)

(21) Appl. No.: 18/568,608

(22) PCT Filed: Jun. 7, 2022
(86) PCT No.: PCT/EP2022/065332

§ 371 Date: Dec. 8, 2023

(30) Foreign Application Priority Data
Jun. 8, 2021 (EP) 21178138.0

(51) Int. Cl. G06F 30/20; G06F 30/12; G06F 119/02

(52) U.S. Cl. CPC G06F 30/20; G06F 30/12; G06F 2119/02

(57) ABSTRACT

A computer-aided method for operating an industrial process feedback control system is provided. The industrial process feedback control system includes a control module and a controlled system. The control module is configured to perform at least one control action to affect at least one variable/parameter of the controlled system. The control action depends on a measured value of the at least one variable.

This application is the National Stage of International Application No. PCT/EP2022/065332, filed Jun. 7, 2022, which claims the benefit of European Patent Application No. EP 21178138.0, filed Jun. 8, 2021. The entire contents of these documents are hereby incorporated herein by reference.

### BACKGROUND

The subject matter disclosed herein relates to facilitating operation of industrial process feedback control systems.

In order to obtain a comprehensive virtual representation (e.g., digital twin) resembling a corresponding real power drive system (e.g., according to IEC 61800-9), not only static attributes but also dynamic behavior is to be represented throughout the complete life cycle.

To be able to provide true value, add integration of all tools involved is to be provided to allow for ease of use and a comprehensive user experience, for both a real product and a virtual product as well. A user should not be forced to use different tools throughout the life cycle regardless of the feedback control system in focus.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a comprehensive solution that facilitates operation of feedback control systems of industrial processes or industrial process steps is provided.

The above-mentioned need is satisfied by providing a computer-aided method for operating a feedback control system for an industrial process (e.g., an industrial process feedback control system), where the industrial process feedback control system includes a control module and a controlled system. The control module is configured to perform at least one control action to affect at least one variable or parameter of the controlled system. The control action depends on a measured value of the at least one variable.

The industrial process feedback control system is a feedback control system for an industrial process or a step in the industrial process.

In an embodiment, the control module may be configured as a complete drive module (e.g., a converter; more particularly, a power or a frequency converter).

In an embodiment, the controlled system may include just a motor, a motor with a driven equipment, where the driven equipment may include a transmission and a load, etc. The load may include an axis of a machining tool for subtractive machining or for additive manufacturing or an axis of an electric car, a pump, or any other motor-driven system.

The variable or parameter may be a power (e.g., input/output power of a converter), a speed, current (e.g., current that is suppled to an asynchronous motor by a frequency converter), torque, frequency, voltage, temperature, flow rate of a fluid, etc.

In an embodiment, the variable or parameter is a variable/parameter that may be directly measured by a physical sensor (such variables are referred to as “primary” variables within the scope of the present disclosure).

The method itself includes an act S1 of configuring the feedback control system (e.g., the control module and the controlled system).

This basic step of configuration of the real feedback control system may be performed at an engineering tool (e.g., at an automation engineering tool).

The method further includes act S2 of generating reference data associated with an operation of the feedback control system. The reference data is generated by the feedback control system. This may be considered as a “test run” of the industrial process feedback control system, while the system is in its basic configuration. The reference data is associated with real measurement data and may, in an embodiment, include one or more measured values of the parameters of the controlled system.

In act S3, a dynamic simulation model of the feedback control system is provided. The dynamic simulation model includes a functional and/or logical model of the control module and a physic model, where the physic model complements the functional and/or logical model to yield the dynamic simulation model.

In an embodiment, the dynamic simulation model is provided at the engineering tool.

In an embodiment, the functional and/or logical model of the control module may be a model (e.g., a somewhat simplified model) of a firmware of the control module or the firmware itself (e.g., no simplification). The functional and/or logical model of the control module is a digital image of the control module, which is a piece of hardware.

The physic model may be a model of a part or of the entire controlled system.

In act S4, configuration parameters of the physic model are set based on the reference data.

This act may be performed at the engineering tool as well or at any other tool that belongs to a configuration layer (e.g., at a web interface).

At act S5, the dynamic simulation model is commissioned (e.g., put into operation). While the dynamic simulation model is executed, the dynamic simulation model generates a simulation data of the feedback control system at a predetermined sampling rate, where the simulation data is associated with the at least one parameter of the controlled system.

In an embodiment, the predetermined sampling rate may be higher than a sampling rate of the feedback control system itself (e.g., the real, physical feedback control system). This may be of a big advantage when detecting anomalies etc. For example, the predetermined sampling rate may be twice as high as the sampling rate of the feedback control system.

The dynamic simulation model may be at the engineering tool or at some other computing device connected (e.g., on a webserver).

Based on the simulation data, an optimization is performed of the configuration parameters (e.g., one or more configuration parameters) of the physic model of the dynamic simulation model (e.g., act S6), and optimized configuration parameters (e.g., a set of optimized configuration parameters) of the physic model are produced. The goal of the optimization is to find optimized configuration parameters such that the dynamic simulation model replicates (e.g., essentially replicates) the reference data.

In this act, further knowledge is gained about the physic model of the real system (e.g., of the real controlled system).

The optimization may be performed at an analytics model component.

In act S8, at least one parameter associated with the industrial process is optimized. The optimal value of at least one parameter associated with the industrial process is obtained by executing the dynamic simulation model and changing configuration parameters of the functional/logical model.

In other words, the dynamic simulation model with the optimally configured physic model is used to simulate at least one parameter associated with the industrial process and to optimize the at least one parameter by changing configuration parameters of the functional/logical model. The configuration parameters of the functional/logical model that led to the optimal value of the at least one parameter associated with the industrial process are optimal configuration parameters for the functional/logical model and, therefore, for the control module.

This implies that the optimal configuration parameters for the functional/logical model may be readily used for configuring the control module and to optimize the industrial process.

In an embodiment, the at least one parameter may be a process variable (e.g., process throughput, energy efficiency, component lifetime, etc.). This variable will be referred to as “secondary variable” within the scope of this disclosure. Such variables cannot be directly measured by physical sensors but are affected by the primary or directly measurable variables and, therefore, by the control module. Sometimes, the secondary variables are related to process' key performance indicators (KPIs).

In an embodiment, the dynamic simulation model generates the simulation data in form of data packets, where each of the data packets includes the simulation data accumulated over a time interval of a predetermined time length, or to generate the simulation data continuously in form of a data stream.

In an embodiment, the engineering tool may include a virtual operator panel of a controller of the control unit.

In an embodiment, the dynamic simulation model is configured via the virtual panel.

In an embodiment, the dynamic simulation model (e.g., the physic model) is configured at a model editor.

In an embodiment, the model editor may include a web interface.

In an embodiment, the predetermined sampling rate is limited by a granularity of the dynamic simulation model (e.g., only by the granularity of the dynamic simulation model).

In an embodiment, the method further includes applying at least one data analytics model to process the simulation data.

In an embodiment, this act may be performed by the analytics model component. For example, the analytics model component may include a monitoring component configured to process the simulation data by applying at least one data analytics model.

In an embodiment, the method further includes visualizing results of processing of the simulation data.

In an embodiment, the monitoring component may be configured to visualize the results of processing of the simulation data.

In an embodiment, the method further includes, based on the simulation data:

identifying patterns and/or anomalies in the behavior of the dynamic simulation model and utilizing defined patterns and/or anomalies to improve/teach the dynamic simulation model.

In an embodiment, the analytics model component includes a model-teaching component configured to, based on the simulation data, identify patterns and/or anomalies in the behavior (e.g., in the simulation) of the dynamic simulation model and utilize defined patterns and/or anomalies to improve/teach the dynamic simulation model.

In an embodiment, the method further includes: receiving data associated with monitoring of the industrial process feedback control system; based on the received data, identifying patterns and/or anomalies in the behavior of the industrial process feedback control system; and utilizing defined patterns and/or anomalies to improve/teach the dynamic simulation model.

In an embodiment, the analytics model component may include a model-teaching component configured to receive data associated with monitoring of the power drive system; based on the received data, identify patterns and/or anomalies in the behavior of the power drive system; and utilize defined patterns and/or anomalies to improve/teach the dynamic simulation model.

In an embodiment, the method further includes optimization of the configuration parameters and of a structure or a topology of the physic model.

In an embodiment, the engineering tool may be configured to define an automation topology.

In an embodiment, the functional and/or logical model stays unchanged in act S6. The parameters of the functional and/or logical model are “frozen” while configuration parameters of the physic model are being optimized.

In an embodiment, the physic model stays unchanged in act S8. The parameters of the physic model are “frozen” while configuration parameters of the functional and/or logical model are being optimized.

In an embodiment, the method further includes reconfiguring the industrial process feedback control system according to the optimized configuration parameters of the functional and/or logical model and the physic model.

In an embodiment, the method further includes repeating acts S2 to S8. For example, the acts S2 to S8 may be repeated regularly or even constantly during feedback control system's operation.

This allows regularly or constantly updating the physic model and/or functional and/or logical model of the control module to facilitate better control and, for example, to achieve better process KPIs.

In an embodiment, the act S6 includes optimizing structure/topology of the physic model.

The above-mentioned need is also satisfied by providing an industrial process feedback control system including a control module and a controlled system, where the control module is configured to perform at least one control action to affect at least one variable/parameter of the controlled system. The control action depends on a measured value of the at least one variable. The industrial process feedback control system also includes a computing device configured to execute the above-described method.

The need is also satisfied by a computer program including instructions to cause the aforementioned industrial process feedback control system to execute the aforementioned method.

The need is also satisfied by a computer readable medium (e.g., a non-transitory computer-readable storage medium) including such computer program.

### BRIEF DESCRIPTION OF THE DRAWINGS

The above and other objects and advantages of the invention will be apparent upon consideration of the following detailed description of certain aspects indicating only a number of possible ways that may be practiced. The description is taken in conjunction with the accompanying drawing, in which like reference characters refer to like parts throughout, and in which:

FIG. 1 shows a flowchart of an example of an implementation of a computer-aided method for operating an industrial process feedback control system method to a power drive system or to a power drive system under a load.

### DETAILED DESCRIPTION

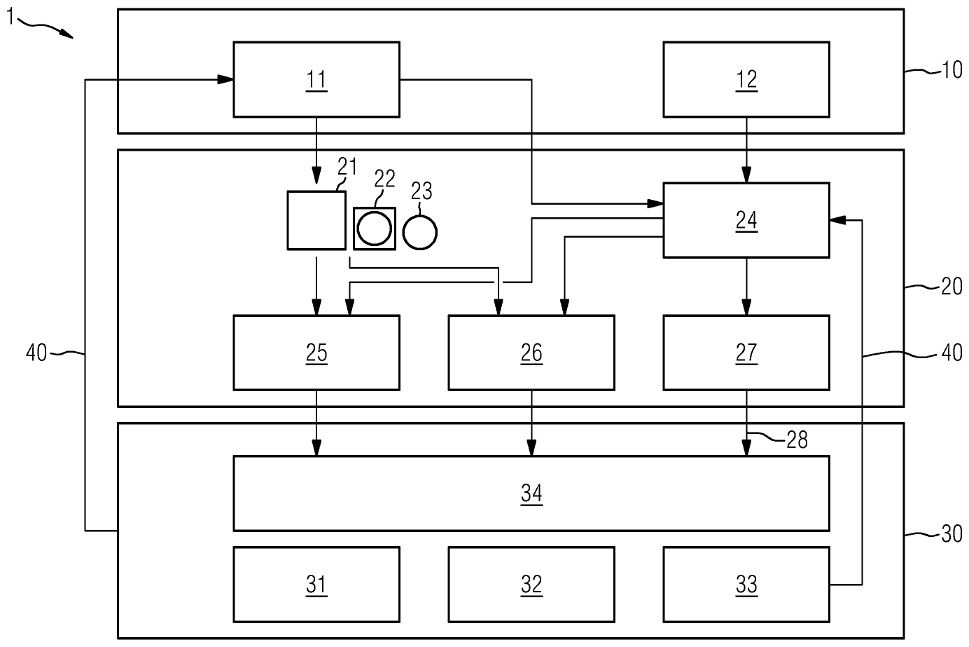

FIG. 1 illustrates a system 1 that includes a memory storing machine-executable components and a processor that is operatively coupled to the memory and is configured to execute the machine-executable components.

In an embodiment, the system 1 may be configured as an edge computing device (e.g., an industrial computer that may be connected to one or more internal networks (intranets) and/or external networks; to one or more cloud services on the Internet, etc.).

The machine-executable components include an engineering tool 11 (e.g., an automation engineering tool). The engineering tool 11 is configured to configure at least one power drive system 21, 22, 23. The power drive system 21, 22, 23 may be a part of an automation system that is configured to automate an industrial plant (e.g., a production line or manufacturing plant). Such power drive systems 21, 22, 23 are often used in various industrial processes. Further, the engineering tool 11 may be configured to configure to define an automation topology of the automation system.

The power drive system 21, 22, 23 (PDS) may be a mains-powered electrical drive system including one or more complete drive modules 21 and one or more motors 22. Each motor 22 may include one or more sensors that may be coupled (e.g., mechanically coupled to the motor shaft). The mechanism or driven load 23 that is driven by the motor may not be a part of the power drive system.

The controlled system may be the motor 22 or the motor 22 and the driven load 23. The control module may be the complete drive module 21.

The complete drive module 21 (CDM) (e.g., converter, such as power or frequency converter) may include a Basic Drive Module (BDM) and possible accessories/auxiliaries (e.g., a power supply module, protection devices, fans, etc.).

The BDM may, for example, according to DIN IEC 61800, include an inverter/converter module including a control for the associated power semiconductors as well as the drive-specific control and regulation for speed, torque, current, frequency, or voltage. The BDM is located between the supply network and the motor and may transmit energy in both directions. The BDM may also include self-protection functions.

The machine-executable components also include dynamic simulation model(s) 24 (e.g., “digital twin”) of the power drive system 21, 22 with or without load the 23. If there is plurality of the power drive systems 21, 22, 23, which may be the case for automation systems for manufacturing plants and/or production lines, there may be a dynamic simulation model 24 for each power drive system 21, 22, 23.

The dynamic simulation model 24 includes a physic or physics-based model and functional and/or logical model of the power drive system 21, 22, 23.

It is important to note that the power drive system 21, 22, 23 may be a real, physical power drive system or its virtual representation (e.g., a replacement or spare circuit diagram of the power drive system). In case of the real power drive system, the system 1 may be seen as a Hardware-in-the-Loop (HiL) simulation. If the real power drive system 21, 22, 23 is a virtual representation of the real power drive system, the system 1 may be seen as a Model-in-the-Loop (MiL) or as a Software-in-the-Loop (SiL) Simulation.

The engineering tool 11 is further configured to allow to configure and to commission the dynamic simulation model 24.

The first configuration (e.g., before commissioning) of the dynamic simulation model 24 is performed by using reference data that is obtained (e.g., measured after a test run of the power drive system with or without load 21, 22, 23).

The reference data serves to perform a first (e.g., basic) configuration of the physic model, since no knowledge about the physic model may be a priori available.

After the configuration parameters of the physic model are set, and, optionally, the structure or topology of the physic model is determined based on the reference data, while the functional and/or logical model remains untouched, the dynamic simulation model 24 is ready to be commissioned, put into operation.

After commissioning, the dynamic simulation model 24 simulates the power drive system with or without load 21, 22, 23.

The dynamic simulation model for the PDS itself 21, 22 is different than the dynamic simulation model for the PDS with load 21, 22, 23. Both dynamic simulation models are models of the feedback control system.

The machine-executable components may also include a model editor 12 for configuring of the dynamic simulation model 24 (e.g., the physic model of the dynamic simulation model 24). This allows for an in-depth configuration of the dynamic simulation model 24.

In an embodiment, the model editor 12 may be a part of the engineering tool 11.

The model editor 12 may include a web interface or may be configured as a web interface.

The engineering tool 11 and the model editor component 12 may form a configuration layer 10 of the system 1.

In an embodiment, the engineering tool 11 may include a virtual operator panel of a controller of the CDM 21 that allows the configuring of the dynamic simulation model 24.

The dynamic simulation model 24 is configured to generate a simulation data 25, 26, 27. The generation of the simulation data is done during execution of the dynamic simulation model. A sampling rate at which the simulation data is generated may be predetermined. For example, the sampling rate may be set up at the engineering tool 11. The simulation data is associated with at least one parameter or variable of the motor 22 or of the motor under load 23. The parameters or variables may be rotation speed (e.g., of a motor), torque, current (e.g., controlling the motor), frequency, voltage, temperature, or any combination thereof.

The predetermined sampling rate is limited (e.g., only) by a granularity of the dynamic simulation model 24. This allows for significantly more detailed simulation data comparing to the data that may be provided by the real power drive systems.

In an embodiment, the dynamic simulation model 24 may be configured to generate the simulation data 25, 26, 27 in form of data packets, where each of the data packets may include the simulation data accumulated over a time interval of a predetermined time length, or to generate the simulation data continuously in form of a data stream. The length of the time interval may be chosen at the engineering tool 11 and/or at the model editor component 12.

In summary, the simulation data may be generated to capture one or more pre-selected drive parameters (e.g., transient and undeviating values) in a predetermined sampling rate and, for example, saving the pre-selected drive parameters to a file storage for further processing or providing a continuous stream of these to a connected computational device. The simulation data may, therefore, be configured as trace files 25, continuous tracing 26, or, when the sampling rate exceeds a sampling rate that is possible (e.g., physically possible) for real power drive systems, as detailed snapshot files or detailed stream file 27.

The real power drive systems may also provide data in the form of trace files or continuously in order to capture selected drive parameters (e.g., transient and undeviating values) in a sampling rate that is limited to the drives internal cycle rate.

The power drive system 21, 22, 23, the dynamic simulation model 24, and the simulation data 25, 26, 27 build an operation layer of the system 1.

Further, the system 1 includes an analytics model component 30 or an analytics layer.

The system 1 includes corresponding interfaces between the machine-executable components and/or layers 10, 20, 30 described herein for transferring information forth between the components and/or the layers.

The analytics model component 30 may include one or more subcomponents and/or data analytics models and is configured to receive 28 the simulation data 25, 26, 27 from the operation layer 20.

In an embodiment, the analytics model component 30 may include a software adaptor 34 to read the simulation data 25, 26, 27 (e.g., the data stream 26, 27) and forward the simulation data 25, 26, 27 to respective recipients 31, 32, 33 within the analytics model component 30.

Based on the simulation data 25, 26, 27, the analytics model component 30 generates an optimization data 40 and provides the optimization data 40 to the engineering tool 11 for optimizing the operation of the power drive system 21, 22, 23 and/or to the dynamic simulation model 24 to improve the simulation of the power drive system 21, 22, 23.

The optimization data 40 includes optimized configuration parameters of the physic model of the dynamic simulation model 24. The dynamic simulation model 24 with the optimally configured physic model essentially replicates the reference data; this is the goal of this optimization).

The (old) configuration parameters of the physic model are then replaced by the optimized configuration parameters of the physic model.

The dynamic simulation model 24 with the optimally configured physic model is then used to simulate at least one parameter associated with the industrial process and to optimize the at least one parameter by changing configuration parameters of the functional/logical model. The configuration parameters of the functional/logical model that led to the optimal value of the at least one parameter associated with the industrial process are optimal configuration parameters for the functional/logical model and for the CDM 21.

These optimal configuration parameters are then used in the CDM 21.

In an embodiment, the analytics model component includes a monitoring component 31 that is configured (e.g., in order to provide the optimization data 40) to process the simulation data 25, 26, 27 (e.g., in the form of trace files from a real power drive system and/or from the dynamic simulation model 24) by applying at least one data analytics model, and to provide the optimization data 40 to the engineering tool 11.

In an embodiment, the monitoring component 31 may be configured to visualize results of processing of the simulation data.

In an embodiment, the analytics model component 30 may include a model-teaching component 33 configured to identify, based on the simulation data 25, 26, 27, patterns and/or anomalies in the behavior (e.g., simulation) of the dynamic simulation model 24, and to utilize 40 defined patterns and/or anomalies to improve and/or teach the dynamic simulation model 24.

In an embodiment, the model-teaching component 33 may be configured to receive data associated with monitoring of the power drive system 21, 22, 23 (e.g., real power drive system) to identify, based on the received data, patterns and/or anomalies in the behavior of the power drive system 21, 22, 23, and to utilize 40 defined patterns and/or anomalies to improve/teach the dynamic simulation model 24.

In an embodiment, the analytics model component 30 may include a preemptive simulation module 32 that allows a simulation of drive system application with an advanced timely offset to identify anomalies in drive system operations before the anomalies occur. This allows for low-latency reactions to possible anomalies.

In summary, the present disclosure provides a comprehensive and integrative solution throughout the machine's life cycle from engineering through operations to service and analytics.

By actively integrating Industrial Internet of Things (IIoT) and virtualization domains of digitalization, added value for machine operators and machine builders alike is generated.

The systems and methods described herein may be also applied to all relevant automation instances (e.g., PLCs), hence allowing users to address their requirements with a universal approach.

The above-described embodiments of the present disclosure are presented for purposes of illustration and not of limitation. For example, the embodiments described with regard to FIGURES are only few examples of the embodiments described in the introductory part. Technical features that are described with regard to systems may be applied to augment methods disclosed herein and vice versa.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for operating a feedback control system for an industrial process, wherein the feedback control system comprises a control module and a controlled system, wherein the control module is configured to perform at least one control action to affect at least one variable of the controlled system, wherein the control action depends on a measured value of the at least one variable, the method being computer-aided and comprising:
configuring the feedback control system;
generating, by the feedback control system, reference data associated with an operation of the feedback control system;
providing a dynamic simulation model of the feedback control system, wherein the dynamic simulation model comprises a functional, logical, or functional and logical model of the control module and a physic model, wherein the physic model complements the functional, logical, or functional and logical model to yield the dynamic simulation model;
setting configuration parameters of the physic model based on the reference data;
commissioning the dynamic simulation model, wherein the dynamic simulation model a is configured to generate simulation data of the feedback control system at a predetermined sampling rate, wherein the simulation data is associated with the at least one variable of the controlled system;
based on the simulation data, optimizing the configuration parameters of the physic model of the dynamic simulation model, so that the dynamic simulation model replicates the reference data, to produce optimized configuration parameters of the physic model;
reconfiguring the physic model using the optimized configuration parameters; and
optimizing at least one parameter associated with the industrial process, wherein an optimal value of at least one parameter associated with the industrial process is obtained by executing the dynamic simulation model and changing configuration parameters of the functional, logical, or functional and logical model.

2. The method of claim 1, wherein the dynamic simulation model is configured to generate the simulation data in form of data packets, and
wherein each of the data packets comprises the simulation data accumulated over a time interval of a predetermined time length.

3. The method of claim 1, wherein the dynamic simulation model is configured to generate the simulation data continuously in the form of a data stream.

4. The method of claim 1, wherein the dynamic simulation model is configured via a virtual panel of an engineering tool.

5. The method of claim 1, wherein the predetermined sampling rate is limited by a granularity of the dynamic simulation model.

6. The method of claim 1, further comprising:
applying at least one data analytics model to process the simulation data.

7. The method of claim 6, further comprising:
visualizing results of processing of the simulation data.

8. The method of claim 1, further comprising:
based on the simulation data, identifying patterns, anomalies, or patterns and anomalies in a behavior of the dynamic simulation model and utilizing defined patterns, anomalies, or patterns and anomalies to improve, teach, or improve and teach the dynamic simulation model.

9. The method of claim 1, further comprising:
receiving data associated with monitoring of the feedback control system, system;
based on the received data, identifying patterns, anomalies, or patterns and anomalies in a behavior of the feedback control system; and
utilizing defined patterns, anomalies, or patterns and anomalies to improve, teach, or improve and teach the dynamic simulation model.

10. The method of claim 1, wherein in the optimizing of the configuration parameters, the functional, logical, or functional and logical model stays unchanged.

11. The method of claim 1, wherein in the optimizing of the at least one parameter, the physic model stays unchanged.

12. The method of claim 1, further comprising:
repeating the generating, the providing, the setting, the commissioning, the optimizing of the configuration parameters, the reconfiguring, and the optimizing of the at least one parameter.

13. The method of claim 1, wherein the optimizing of the configuration parameters comprises optimizing structure, topology, or structure and topology of the physic model.

14. An feedback control system for an industrial process, the feedback control system comprising:
a control module;
a controlled system, wherein the control module is configured to perform at least one control action to affect at least one variable, parameter, or variable and parameter of the controlled system, wherein the control action depends on a measured value of the at least one variable; and
a computing device configured to operate the feedback control system, the computing device being configured to operate the feedback control system comprising the computing device being configured to:
configure the feedback control system;
generate reference data associated with an operation of the feedback control system;
provide a dynamic simulation model of the feedback control system, wherein the dynamic simulation model comprises a functional, logical, or functional and logical model of the control module and a physic model, wherein the physic model complements the functional, logical, or functional and logical model to yield the dynamic simulation model;
set configuration parameters of the physic model based on the reference data;
commission the dynamic simulation model, wherein the dynamic simulation model is configured to generate simulation data of the feedback control system at a predetermined sampling rate, wherein the simulation data is associated with the at least one variable of the controlled system;
based on the simulation data, optimize the configuration parameters of the physic model of the dynamic simulation model, so that the dynamic simulation model replicates the reference data, to produce optimized configuration parameters of the physic model;
reconfigure the physic model using the optimized configuration parameters; and
optimize at least one parameter associated with the industrial process, wherein an optimal value of at least one parameter associated with the industrial process is obtained by execution of the dynamic simulation model and change of configuration parameters of the functional, logical, or functional and logical model.

15. (canceled)

16. (canceled)

17. In a non-transitory computer-readable storage medium that stores instructions executable by one or more processors to operate a feedback control system for an industrial process, wherein the feedback control system comprises a control module and a controlled system, wherein the control module is configured to perform at least one control action to affect at least one variable of the controlled system, wherein the control action depends on a measured value of the at least one variable, the instructions comprising:
configuring the feedback control system;
generating, by the feedback control system, reference data associated with an operation of the feedback control system;
providing a dynamic simulation model of the feedback control system, wherein the dynamic simulation model comprises a functional, logical, or functional and logical model of the control module and a physic model, wherein the physic model complements the functional, logical, or functional and logical model to yield the dynamic simulation model;
setting configuration parameters of the physic model based on the reference data;
commissioning the dynamic simulation model, wherein the dynamic simulation model is configured to generate simulation data of the feedback control system at a predetermined sampling rate, wherein the simulation data is associated with the at least one variable of the controlled system;
based on the simulation data, optimizing the configuration parameters of the physic model of the dynamic simulation model, so that the dynamic simulation model replicates the reference data, to produce optimized configuration parameters of the physic model;
reconfiguring the physic model using the optimized configuration parameters; and
optimizing at least one parameter associated with the industrial process, wherein an optimal value of at least one parameter associated with the industrial process is obtained by executing the dynamic simulation model and changing configuration parameters of the functional, logical, or functional and logical model.

18. The non-transitory computer-readable storage medium of claim 17, wherein the dynamic simulation model is configured to generate the simulation data in form of data packets, and
wherein each of the data packets comprises the simulation data accumulated over a time interval of a predetermined time length.

19. The non-transitory computer-readable storage medium of claim 17, wherein the dynamic simulation model is configured to generate the simulation data continuously in the form of a data stream.

20. The method of claim 5, wherein the predetermined sampling rate is higher that a sampling rate of the feedback control system.
